(19) United States
(12) Patent Application Publication
(10) Pub. No.: US 2009/0184607 A1
(43) Pub. Date: Jul. 23, 2009

(54) Micro motor structure

(75) Inventors: Alex Horng, Kaohsiung City (TW); I-Yu Huang, Kaohsiung City (TW)

Correspondence Address: BACON & THOMAS, PLLC, 625 SLATERS LANE, FOURTH FLOOR, ALEXANDRIA, VA, 22314-1176, US

(73) Assignee: Sunonwealth Electric Machine Industry Co., Ltd., Kaohsiung City (TW)

(21) Appl. No.: 12/068,579

(22) Filed: Feb. 8, 2008

(30) Foreign Application Priority Data
Jan. 21, 2008 (TW) 097102164

(51) Int. Cl. H02K 57/00

(52) U.S. Cl. 310/40 MM

(57) ABSTRACT

The present invention relates to a micro motor structure, which includes a hub, a rib structure, an inner ring, an outer ring and at least two micro actuators in which a top edge of the hub is projected outwards to form an upper lid having at least two protrusions in form of rectangular tooth, triangle or arc so that the upper lid is in point contact with the inner wall of the inner ring. As such, in spite of collision between the inner ring and the upper lid, when the micro actuators drive the rib structure, the inner ring and the outer ring to rotate, mutual abrasion between the upper lid and the inner ring is alleviated due to the point contact therebetween, thereby prolonging the lifespan of the micro motor.

### FIELD OF THE INVENTION

The present invention relates to a micro motor structure, and more particularly to a structure that can prevent abrasion and malfunction of parts to prolong the lifespan thereof.

### BACKGROUND OF THE INVENTION

As shown in FIG. 1, a micro motor includes: a hub 10, a rib structure 20, an inner ring 30, an outer ring 40 and at least two micro actuators 50.

Please further refer to the illustration of FIG. 2, which uses the Low Pressure Chemical Vapor Deposition (LPCVD) to deposit a low-stress (250 MPa) Si3N4 film on a substrate 60 to serve as an insulation layer 61. The hub 10 is a stationary part fixed on the insulation layer 61 and takes the form of a hollow and ␣-like disc whose top edge is projected outwards to form an upper lid 101;

The rib structure 20 and the inner ring 30 are both annular, the inner ring 30 is located to surround the upper lid 101 and the hole diameter of the inner ring 30 shall be slightly larger than the external diameter of the upper lid 101, the rib structure 20 is fixed at a bottom portion of the inner ring 30 and is located below the upper lid 101 for supporting the inner ring 30 to rotate, and the inner hole diameter of the rib structure 20 shall be greater than the maximum diameter of the hub 10 but less than the hole diameter of the inner ring 30 and the maximum external diameter of the upper lid 101 so that the upper lid 101 can be positioned above the rib structure 20 to prevent the rib structure 20 from disengaging as a result of rotation;

the outer ring 40 is also annular and the hole diameter of the outer ring shall be far greater than the maximum external diameter of the inner ring 30, a plurality of micro actuators 50 are provided between the inner ring 30 and the outer ring 40 and each of them is connected with the inner ring 30 and the outer ring 40 by using a support cantilever beams 51, and a bushing 52 and an actuation plate 53 are disposed on each support cantilever beam 51; and

the insulation layer 61 has an upper electrode 62 and a lower electrode 63 disposed thereon, and the actuation plate 53 is bent due to an electrostatic force while it is subjected to a given driving voltage and is displaced by the energy of tensile stress stored therein after removing the given voltage to complete a step motion (actuation theory of micro actuator is a prior art and thus is briefly depicted in the present invention).

The upper lid 101 of a conventional micro motor has an annular and protruded shape; as a result, there is a possibility that serious surface contact and abrasion taken place between the inner wall of the inner ring 30 and the upper lid 11 due to minor deviation when the inner ring 30 and the outer ring 40 rotate, and especially when the size of micro actuator is smaller than 2×2 (mm), the surface contact and abrasion between the inner wall of the inner ring 30 and the upper lid 101 easily result in damage and malfunction between the inner wall of the inner ring 30 and the upper lid 30.

### SUMMARY OF THE INVENTION

In view of the foregoing concern, the present invention thus provides a micro motor structure providing an upper lid with at least two protrusions being in point contact with the inner wall of an inner ring to avoid abrasion and malfunction of parts, including a hub being a stationary part fixed on an insulation layer, and taking the form of a hollow and ␣-like disc whose top edge is projected outward to form an upper lid taking the form of at least two rectangular, triangular or arc-like protrusions; an inner ring having an annular form whose hole diameter is slightly larger than the maximum external diameter of the upper lid, located to surround the upper lid, and being in point contact with the upper lid; a rib structure taking an annular form, fixed on a bottom portion of the inner ring, and located below the upper lid, in which its inner hole diameter is greater than the external diameter of the hub but less than the hole diameter of the inner ring and the maximum external diameter of the upper lid, so that the upper lid is positioned above the rib structure as a stopper; an outer ring taking an annular form and having an hole diameter far greater than the maximum external diameter of the inner ring; and at least two micro actuators connected with the inner ring and the outer ring.

Therefore, in spite of collision between the inner wall of the inner ring and the upper lid due to minor deviation, when the micro actuators drive the rib structure, the inner ring and the outer ring to rotate, a point contact condition is present between the inner wall of the inner ring and the upper lid because the upper lid has the form of at least two rectangular, triangular or arc-like protrusions, so as to alleviate mutual abrasion between parts to prolong the lifespan of the micro motor.

### BRIEF DESCRIPTION OF THE DRAWINGS

FIG. 1 is an external schematic view showing a conventional structure;

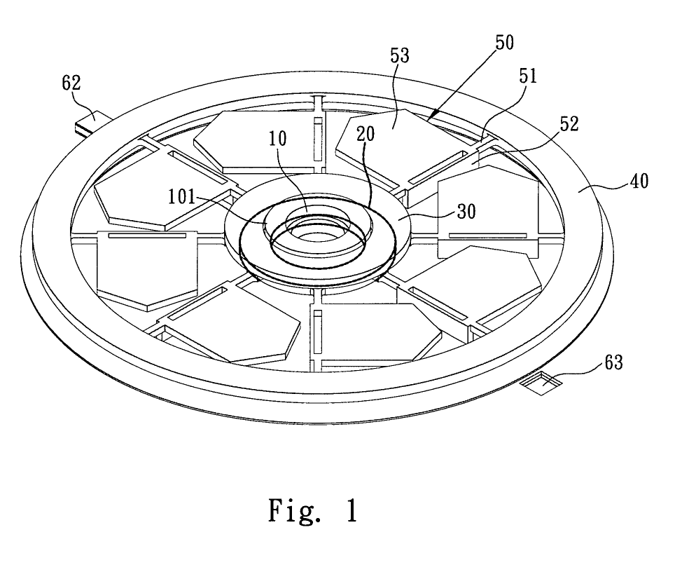

FIG. 2 is an cross-sectional view showing a conventional structure;

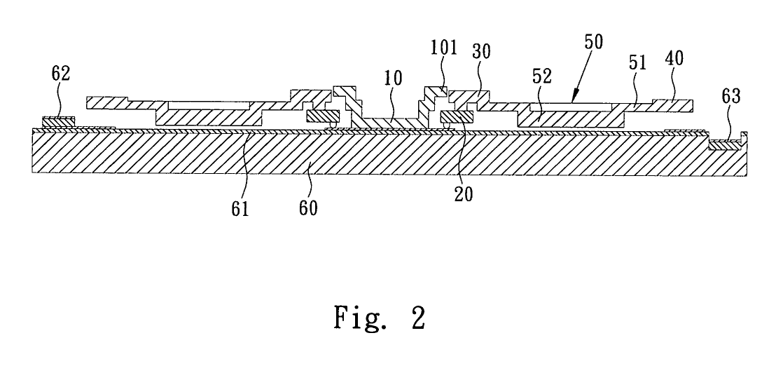

FIG. 3 is an external schematic view showing a first preferred embodiment of the present invention;

FIG. 4 is a planar schematic view showing a preferred embodiment of the present invention;

FIG. 5 is an external schematic view showing a second preferred embodiment of the present invention;

FIG. 6 is an planar schematic view showing a second preferred embodiment of the present invention;

FIG. 7 is an external schematic view showing a third preferred embodiment of the present invention;

FIG. 8 is a planar schematic view showing a third preferred embodiment of the present invention;

FIG. 9 is an external schematic view showing a fourth preferred embodiment of the present invention; and

FIG. 10 is a planar schematic view showing a fourth preferred embodiment of the present invention.

### DETAILED DESCRIPTION OF THE PREFERRED EMBODIMENT

The present invention relates to a micro motor structure whose upper lid has at least two protrusions and is in point contact with an inner ring so as to prevent abrasion and malfunction of parts.

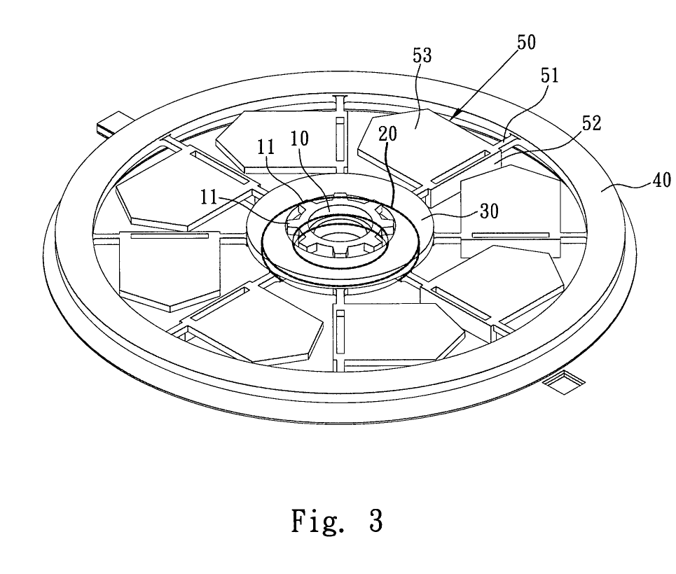

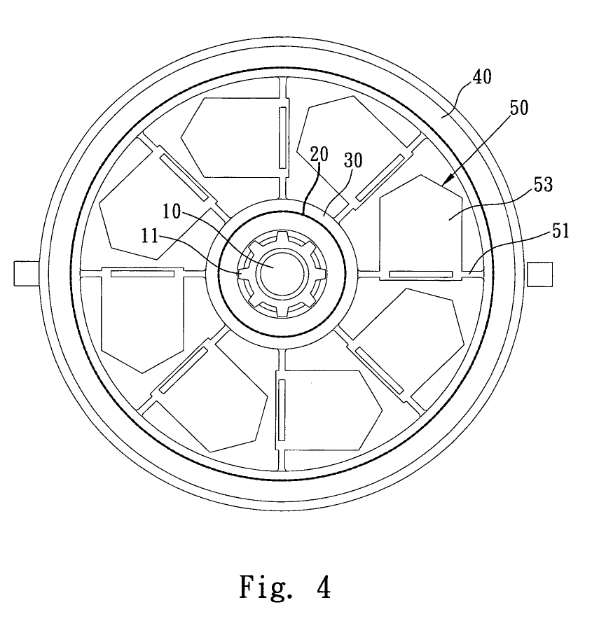

As shown in FIG. 3 and FIG. 4 which illustrate a first preferred embodiment of the present invention, the micro motor structure includes:

a hub 10, a rib structure 20, an inner ring 20, an outer ring 40 and at least two micro actuators 50, in which the hub 10 is a stationary part and takes the form of a ␣-like disc whose top edge is projected outwards to form an upper lid 11, and the upper lid 11 has at least two protrusions in form of rectangular tooth;

the rib structure 20 and the inner ring 30 all take an annular form, the inner ring 30 is located to surround the upper lid 11 and the diameter of the hole of the inner ring 30 shall be slightly greater than the maximum external diameter of the upper lid 11, the rib structure 20 is fixed at a bottom portion of the inner ring 30 and is located below the upper lid 11 for supporting the inner ring 30 to rotate, and the inner hole diameter of the rib structure 20 shall be greater than the external diameter 10 of the hub but less than the hole diameter of the inner ring and the maximum external diameter of the upper lid 11 so that the upper lid 11 is positioned above the rib structure 20 as a stopper to prevent the rib structure 20 to disengage as a result of rotation; and

the outer ring 40 is also annular, the hole diameter of the outer ring 40 shall be far greater than the maximum external diameter of the inner ring 30, a plurality of micro actuators 50 are provided between the inner ring 30 and the outer ring 40 and each of them is connected with the inner ring 30 and the outer ring 40 by using a support cantilever beam 51, and a bushing and an actuation plate 53 are disposed on each support cantilever beam 51.

Therefore, despite collision between the inner wall of the inner ring 30 and the upper lid 11 due to minor deviation, when the micro actuators 50 drive the rib structure 20, the inner ring 30 and the outer ring 40 to rotate, the upper lid 11 is in point contact with the inner wall of the inner ring 30 because the upper lid 11 provides the at least two protrusions in form of rectangular tooth, so as to reduce mutual abrasion between the parts to prolong the lifespan of the micro motor.

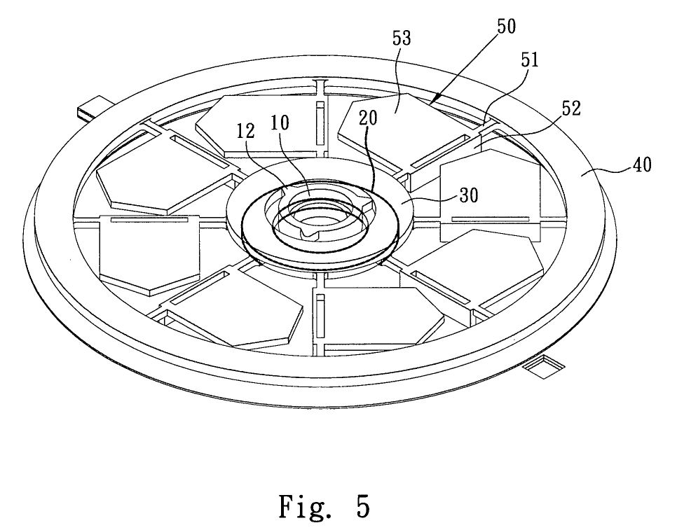

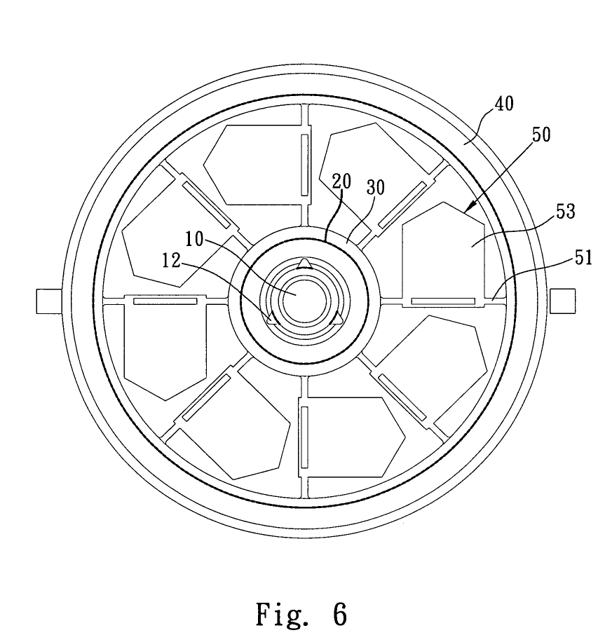

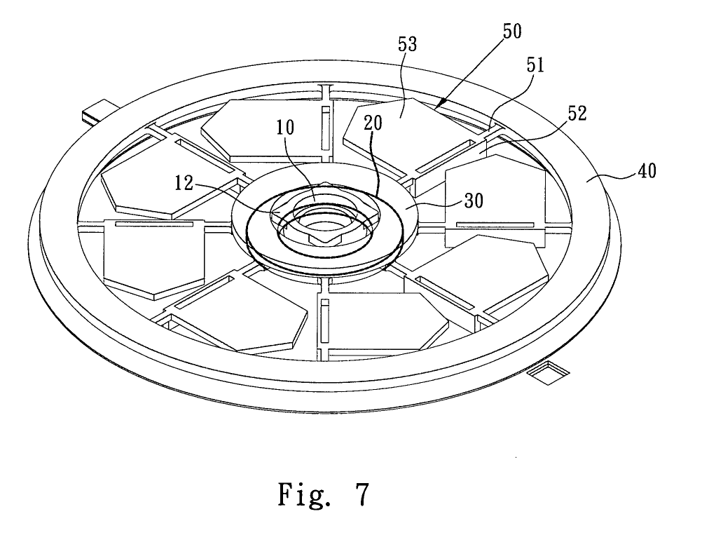

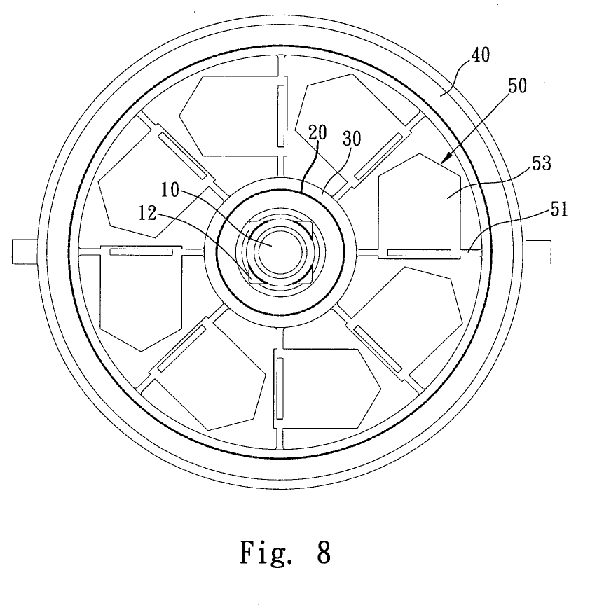

As shown in FIG. 5 and FIG. 6 which illustrate a second preferred embodiment of the present invention, the micro motor includes: a hub 10, a rib structure 20, an inner ring 30, an outer ring 40 and at least two micro actuators 50, in which a top edge of the hub 10 is projected outwards to form an upper lid 12, and the upper lid 12 has at least two triangular protrusions (three triangular protrusions as shown in the second preferred embodiment in FIG. 5 and FIG. 6, and four triangular protrusions as shown in the third preferred embodiment in FIG. 7 and FIG. 8);

the rib structure 20 and the inner ring 30 are all annular, the inner ring 30 is located to surround the upper lid 12, the hole diameter of the inner ring 30 shall be slightly greater than the maximum external diameter of the upper lid 12, the rib structure 20 is fixed at a bottom portion of the inner ring 30 and is located below the upper lid 12 for supporting the inner ring 30 to rotate, and the inner hole diameter of the rib structure 20 shall be greater than the external diameter of the hub 10 but less than the hole diameter of the inner ring 30 and the maximum external diameter of the upper lid 12, so that the upper lid 12 is positioned above the rib structure as a stopper to prevent the rib structure from disengaging as a result of rotation;

the outer ring 40 is also annular and the hole diameter thereof shall be far greater than the maximum external diameter of the inner ring 30, a plurality of micro actuators 50 are provided between the inner ring 30 and the outer ring 40 and each of them is connected with the inner ring 30 and the outer ring 40 by using a support cantilever beam 51, and a bushing 52 and an actuation plate 53 are disposed on each support cantilever beam 51.

Therefore, despite collision between the inner wall of the inner ring 30 and the upper lid 11 due to minor deviation, when the micro actuators 50 drive the rib structure 20, the inner ring 30 and the outer ring 40 to rotate, the upper lid 12 is in point contact with the inner wall of the inner ring 30 because the upper lid 12 provides the at least two triangular protrusions, so as to reduce mutual abrasion between the parts to prolong the lifespan of the micro motor.

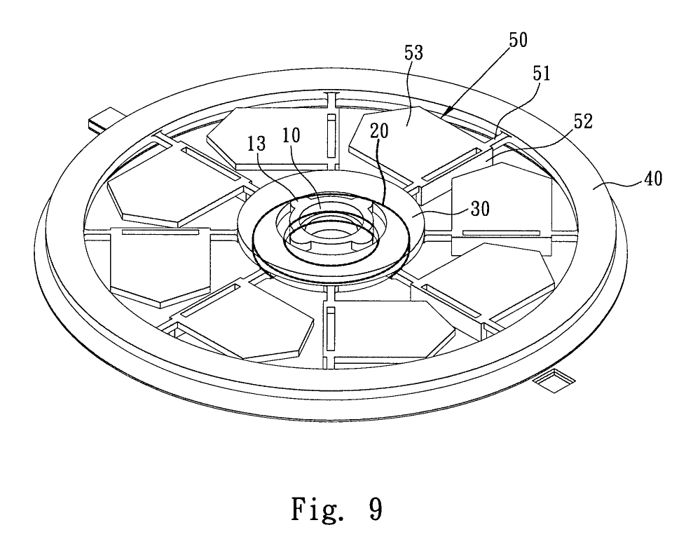

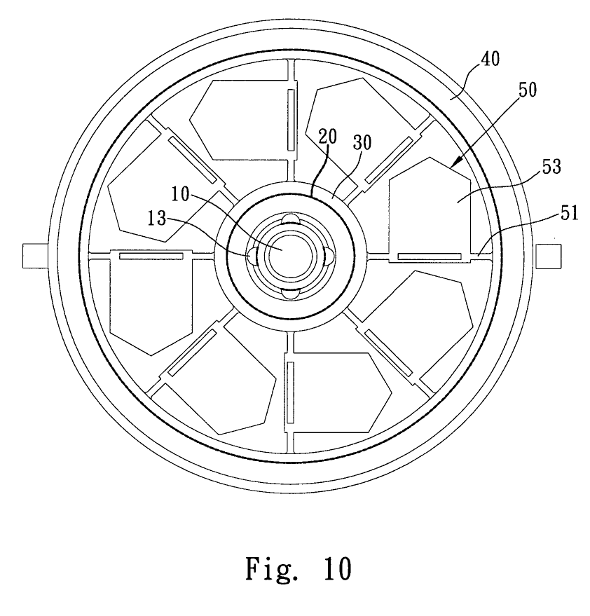

As shown in FIG. 9 and FIG. 10 which illustrate a fourth preferred embodiment of the present invention, the micro motor includes: a hub 10, a rib structure 20, an inner ring 30, an outer ring 40 and at least two micro actuators 50, in which a top edge of the hub 10 is projected outwards to form an upper lid 13, and the upper lid 13 has at least two arc-like protrusions (four protrusions as shown in FIG. 9 and FIG. 10). Therefore, despite collision between the inner wall of the inner ring 30 and the upper lid 13 due to minor deviation, when the micro actuators 50 drive the rib structure 20, the inner ring 30 and the outer ring 40 to rotate, the upper lid 13 is in point contact with the inner wall of the inner ring 30 because the upper lid 13 provides the at least two arc-like protrusions, so as to reduce mutual abrasion between the parts to prolong the lifespan of the micro motor.

In sum, from the above-mentioned characteristics those features not only have a novelty among similar products and a progressiveness but also have an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A micro motor structure, comprising:
a hub being a stationary part, taking a cylindrical form, and having a top edge projected outwards to form an upper lid with at least two protrusions;
an inner ring taking an annular form, located to surround the upper lid, having a hole diameter being slightly greater than a maximum external diameter of the upper lid, and being in point contact with the upper lid;
a rib structure taking an annular form and fixed at a bottom portion of the inner ring, having a diameter of an inner hole being greater than an external diameter of the hub but less than the hole diameter of the inner ring and the maximum external diameter of the upper lid, so that the upper lid is positioned above the rib structure to serve as a stopper; and
at least two micro actuators connected between the inner ring and the outer ring.

2. The micro motor structure as set forth in claim 1, wherein the protrusions of the upper lid take the form of rectangular tooth.

3. The micro motor structure as set forth in claim 1, wherein the protrusions of the upper lid take the form of triangle.

4. The micro motor structure as set forth in claim 1, wherein the protrusions of the upper lid take the form of arc.

5. The micro motor structure as set forth in claim 1, wherein the hub is a hollow and ␣-like disc.

6. The micro motor structure as set forth in claim 1, wherein each of the micro actuators is connected with the inner ring and the outer ring by using a support cantilever beam, and a bushing and an actuation plate are disposed on each support cantilever beam.
